(19) United States
(12) Patent Application Publication
(10) Pub. No.: US 2009/0189835 A1
(43) Pub. Date: Jul. 30, 2009

(54) Display Device

(76) Inventors: Dong-Gyu KIM, Yongin-si (KR); Byoung-Sun Na, Hwaseong-si (KR); Gwang-Bum Ko, Asan-si (KR)

Correspondence Address: Haynes and Boone, LLP;IP Section, 2323 Victory Avenue, SUITE 700, Dallas, TX, 75219, US

(21) Appl. No.: 12/336,421

(22) Filed: Dec. 16, 2008

(30) Foreign Application Priority Data
Jan. 30, 2008 (KR) 2008-9627

(51) Int. Cl. G09G 3/30

(52) U.S. Cl. 345/80

(57) ABSTRACT

A display device according to one or more embodiments includes a display panel, a source driver part and a gate driver part. The display panel includes a first substrate and a second substrate. According to an embodiment, the first substrate includes a first side extending in a substantially straight line and having a first end and a second end, and a second side extending in a substantially round shape from the first end of the first side to the second end of the first side. A plurality of gate lines is substantially parallel with the first side. The second substrate has a shape corresponding to the first substrate. The source driver part is disposed at the first side, and the gate driver part is disposed at the second side. Thus, a display panel having various shapes besides a rectangular shape may be manufactured according to one or more embodiments.

### CROSS-REFERENCE TO RELATED APPLICATIONS

The present application claims priority to and benefit from Korean Patent Application No. 2008-9627, filed on Jan. 30, 2008 in the Korean Intellectual Property Office (KIPO), the contents of which are herein incorporated by reference in their entirety.

### BACKGROUND

1. Technical Field

Embodiments of the present invention generally relate to a display device. More particularly, embodiments of the present invention relate to a display device including a display panel having various shapes.

2. Description of the Related Art

Generally, a display panel employed in a display device includes a thin-film transistor (TFT) substrate having a TFT, and a color filter substrate facing the TFT substrate having a color filter. In addition to the TFT, a gate line and a source line arranged substantially perpendicular to each other are formed on the TFT substrate. The gate line is connected to a gate driver part, and the source line is connected to a source driver part. The gate and source driver parts are electrically connected to the TFT substrate, and various methods of connecting the gate and source driver parts to the TFT substrate have been developed.

The display panel is manufactured to typically have a rectangular shape. The gate driver part is electrically connected to a first side of the rectangular shape, and the source driver part is electrically connected to a second side substantially perpendicular to the first side.

Nowadays, as display devices are employed in various industrial fields, a display panel having various shapes is required. However, when a display panel is manufactured to have various shapes, the gate driver part and the source driver part are difficult to connect to the TFT substrate. In addition, the length of the gate line varies in accordance with the shape of the display panel, so that an output signal of the gate line is difficult to maintain.

### SUMMARY

Embodiments of the present invention may obviate the above problems and thus, embodiments of the present invention provide a display device having a display panel having various shapes.

In one aspect according to an embodiment of the present invention, a display device includes a display panel, a source driver part and a gate driver part. The display panel displays an image, and includes a first substrate and a second substrate. The first substrate includes a first side extending in a substantially straight line and having a first end and a second end, and a second side extending in a substantially round shape from the first end of the first side to the second end of the first side. A plurality of gate lines is formed on the first substrate and is substantially parallel with the first side. The second substrate faces the first substrate, and has a shape corresponding to the first substrate. The source driver part is disposed at the first side to transfer a driving signal to the display panel. The gate driver part is disposed at the second side and is electrically connected to the gate lines to drive the gate lines using a gate driving signal.

A gate driver circuit of the gate driver part may be directly integrated on the first substrate. The gate driver part may include a shift register including a plurality of stages dependently connected to each other. An output terminal of each stage may be connected to an associated gate line so that the gate lines are sequentially selected by an output signal of each stage.

Pixels may be connected to the stages, and the number of the pixels, each having red, green and blue sub-pixels, may decrease as the stages are arranged from a first end of the second side connected to the first end of the first side to a middle portion of the second side.

The stages may be arranged substantially parallel with the first side from the first end of the second side to a first position along the second side, arranged to form an angle of about 45 degrees with respect to the first side from the first position to a second position along the second side, and arranged to form an angle of about 90 degrees with respect to the first side from the second position to the middle portion of the second side along the second side.

Alternatively, an angle that each stage forms with respect to the first side may increase from about 0 degrees to 90 degrees, as the stages are arranged from the first end of the second side to the middle portion of the second side.

A capacitance of a capacitor interconnecting the output terminal of each stage and the associated gate line may increase to stably drive the gate lines, as the stages are arranged from the first end of the second side to the middle portion of the second side.

In another aspect according to an embodiment of the present invention, a display device includes a display panel, a source driver part and a gate driver part. The display panel displays an image, and includes a first substrate and a second substrate. The first substrate includes a first side serving as a bottom side, a second side and a third side that define a substantially triangular shape. A plurality of gate lines is formed on the first substrate and is substantially parallel with the first side. The second substrate faces the first substrate and has a shape corresponding to the first substrate. The source driver part is disposed at the first side to transfer a driving signal to the display panel. The gate driver part is disposed at one or both of the second side and the third side and is electrically connected to the gate lines to drive the gate lines using a gate driving signal.

The triangular shape defined by the first, second and third sides may be an equilateral triangular shape.

The gate driver circuit of the gate driver part may be directly integrated on the first substrate. The gate driver part may include a shift register including a plurality of stages dependently connected to each other. An output terminal of each stage may be connected to an associated gate line so that the gate lines are sequentially selected by an output signal of each stage. The stages may be arranged substantially parallel with the first side.

Pixels may be connected to the stages, and the number of the pixels, each having red, green and blue sub-pixels, may decrease as the stages are arranged from at least one end of the first side along either one or both of the second side and the third side. In addition, a capacitance of a capacitor interconnecting the output terminal of each stage and the associated gate line may increase, to stably drive the gate lines, as the stages are arranged from at least one end of the first side along either one or both of the second side and the third side.

In still another aspect according to an embodiment of the present invention, a display device includes a display panel, a source driver part and a gate driver part. The display panel displays an image, and includes a first substrate and a second substrate. The first substrate includes a first side serving as a bottom side, a second side, a third side serving as a top side to be substantially parallel with the first side, and a fourth side that define a substantially trapezoidal shape. A plurality of gate lines is formed on the first substrate and is substantially parallel with the first side. The second substrate faces the first substrate and has a shape corresponding to the first substrate. The source driver part is disposed at the first side to transfer a driving signal to the display panel. The gate driver part is disposed at one or both of the second side and the fourth side and is electrically connected to the gate lines to drive the gate lines using a gate driving signal.

The gate driver circuit of the gate driver part may be directly integrated on the first substrate. The gate driver part may include a shift register including a plurality of stages dependently connected to each other. An output terminal of each stage may be connected to an associated gate line so that the gate lines are sequentially selected by an output signal of each stage. The stages may be arranged substantially parallel with the first side and the third side.

Pixels may be connected to the stages, and the number of the pixels, each having red, green and blue sub-pixels, may decrease as the stages are arranged from at least one end of the first side along either one or both of the second side and the fourth side. A capacitance of a capacitor interconnecting the output terminal of each stage and the associated gate line may increase, to stably drive the gate lines, as the stages are arranged from at least one end of the first side along either one or both of the second side and the fourth side.

### BRIEF DESCRIPTION OF THE DRAWINGS

The above and other features and advantage points of the embodiments of the present invention will become more apparent by describing in detail exemplary embodiments thereof with reference to the accompanying drawings, in which:

FIG. 1 is a plan view illustrating a display device according to an exemplary embodiment of the present invention;

FIG. 2 is an enlarged view of a portion ‘A’ illustrated in FIG. 1;

FIG. 3 is a plan view illustrating another example of the gate driver part of the display device illustrated in FIG. 1;

FIG. 4 is an enlarged view of a portion ‘B’ illustrated in FIG. 3;

FIG. 5 is a plan view illustrating a display device according to another exemplary embodiment of the present invention; and

FIG. 6 is a plan view illustrating a display device according to still another exemplary embodiment of the present invention.

### DETAILED DESCRIPTION

Embodiments of the invention are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it may be directly on, connected or coupled to the other element or layer, or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the embodiments of the present invention described herein.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the accompanying drawings.

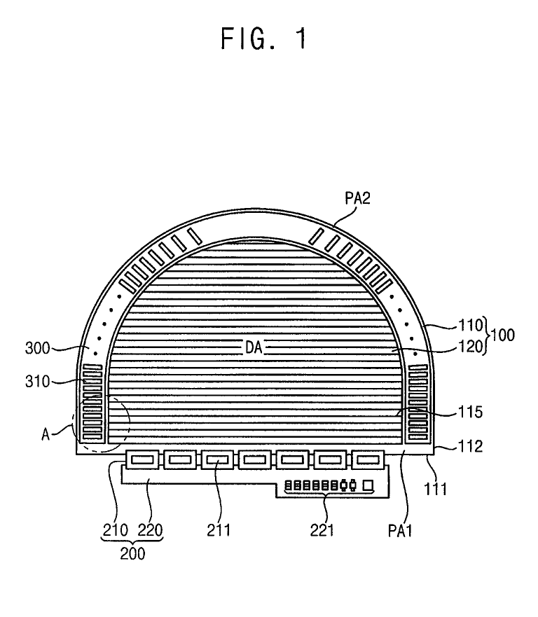

FIG. 1 is a plan view illustrating a display device according to an exemplary embodiment of the present invention.

Referring to FIG. 1, a display device according to an exemplary embodiment of the present invention includes a display panel 100, a source driver part 200 and a gate driver part 300. Although not shown in FIG. 1, the display device may further include a backlight assembly generating light, optical members improving the optical efficiency of the light, a chassis part covering and supporting the backlight assembly and the display panel, etc.

The display panel 100 has a display area DA in which an image is displayed and first and second non-display areas PA1 and PA2 located at a periphery of the display area DA. The display panel 100 includes a first substrate 110 and a second substrate 120. The first substrate 110 includes a first side 111 and a second side 112. The first side 111 has a first end and a second end, and extends in a substantially straight line. The second side 112 has a first end and a second end. The first end of the second side 112 is connected to the first end of the first side 111, and the second end of the second side 112 is connected to the second end of the first side 111. The second side 112 extends in a substantially round shape from the first end of the first side 111 to the second end of the first side 111. The round shape includes, for example, an arc shape, and a predetermined distance from the first and second ends of the first side 111 may correspond to a straight line. Alternatively, the round shape may include one of various curved shapes transformed from arc shapes.

Although not shown in FIG. 1, a plurality of pixel electrodes, thin-film transistors (TFTs), each of which may apply driving voltages to the pixel electrodes, and signal lines driving the TFTs may be formed on the first substrate 110. The signal lines include a gate line 115 transferring a gate driving signal and a source line (not shown) transferring a source driving signal.

In FIG. 1, since the source driver part 200 is disposed at the first side 111 of the first substrate 110, the gate lines 115 may be arranged substantially parallel with the first side 111 of the first substrate 110. In FIG. 1, since the first substrate 110 includes the first side 111 extending in a substantially straight line and the second side 112 extending in a substantially round shape, the gate lines 115 formed on the first substrate 110, which are substantially parallel with the first side 111, have different lengths from each other.

The second substrate 120 faces the first substrate 110, and has a shape corresponding to the first substrate 110. The second substrate 120 is disposed to correspond to the display area DA of the first substrate 110. For example, when the first substrate 110 has a semi-circular shape, the second substrate 120 may also have a semi-circular shape. The second substrate 120 is not disposed in the non-display areas PA1 and PA2 of the first substrate 110. The source driver part 200 and the gate driver part 300 may be formed in the non-display areas PA1 and PA2 of the first substrate 110.

The second substrate 120 may include a plurality of color filters having red, green and blue (RGB) sub-pixels to display a predetermined color. The color filters correspond to the pixel electrodes of the first substrate 110. A liquid crystal layer (not shown) including liquid crystal molecules may be formed between the first substrate 110 and the second substrate 120. The liquid crystal layer controls optical transmissivity.

The source driver part 200 is disposed in the first non-display area PA1, and arranged adjacent to the first side 111 of the first substrate 110. Since the first side 111 of the first substrate 110 extends in a substantially straight line, the source driver part 200 may be arranged in a substantially straight line. The source, driver part 200 includes a source flexible printed circuit board (FPCB) 210 and a source printed circuit board (PCB) 220. A source driver chip 211 is mounted on the source FPCB 210 to serve as a source driver circuit. The source FPCB 210 electrically connects the first side 111 of the first substrate 110 to the source PCB 220. An electric circuit is formed on the source PCB 220 to drive a source driver circuit, and various electric elements 221 are also mounted on the source PCB 220. The source driver part 200 transfers a driving signal to the display panel 100.

The gate driver part 300 is disposed in the second non-display area PA2, and arranged adjacent to the second side 112 of the first substrate 110. For example, when the second side 112 has an arc shape, the gate driver part 300 may also be arranged in an arc shape. The gate driver part 300 is electrically connected to the gate lines 115 to sequentially output a gate driving signal to the gate lines 115.

In FIG. 1, the gate driver part 300 is formed in an entire portion of the second non-display area PA2. Alternatively, the gate driver part 300 may be formed in only a half portion of the second non-display area PA2. That is, as shown in FIG. 1, the gate driver part 300 may be arranged from the first end of the second side 112 connected to the first end of the first side 111 to the second end of the second side 112 connected to the second end of the first side 111. Alternatively, the gate driver part 300 may be arranged from the first end of the second side 112 connected to the first end of the first side 111 to a middle portion of the second side 112. When the gate driver part 300 is formed in the entire portion of the second non-display area PA2, the gate lines 115 may be stably driven with less power.

The gate driver part 300 includes a gate driver circuit 310, which may be formed directly on the first substrate 110 through a thin film process. In other words, the gate driver circuit 310 may be formed directly on the first substrate 110 including an insulating material such as glass or ceramic through a similar process as a process through which the TFTs are formed. Gate driver circuit 310 may be simultaneously formed with the TFTs. Since the gate driver circuit 310 is formed directly on the first substrate 110, the gate driver circuit 310 may be easily formed adjacent to the second side 112 in the second non-display area PA2 of the first substrate 110 even though the shape of the first substrate 110 may vary.

Alternatively, not shown in FIG. 1, the gate driver part 300 may include a tape carrier package (TCP) having an FPCB and a gate driver chip formed on the FPCB, and may be arranged adjacent to and along the second side 112 of the first substrate 110. In addition, the gate driver part 300 includes gate driver chips, which may be arranged adjacent to and along the second side 112 of the first substrate 110 by using a chip-on-glass (COG) method.

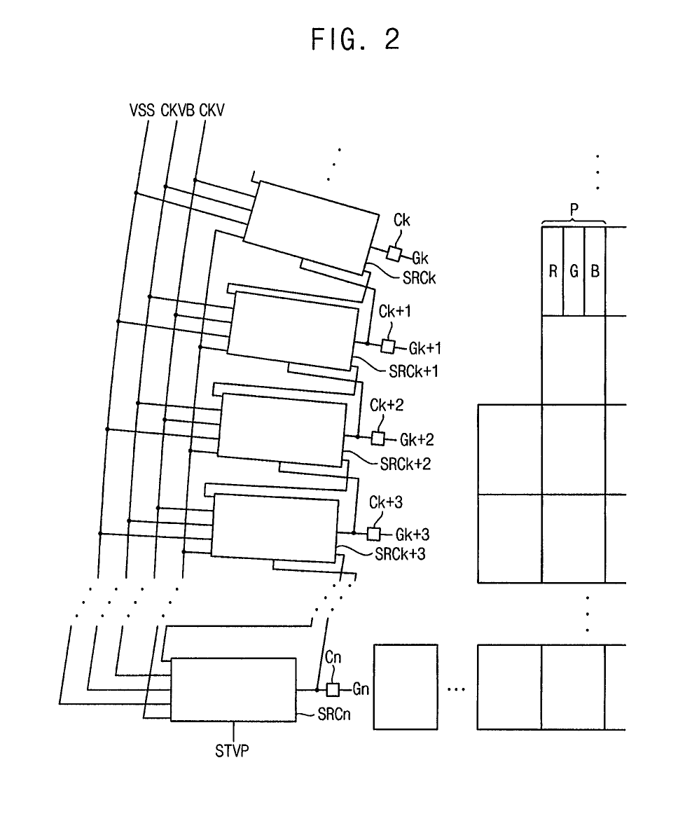

FIG. 2 is an enlarged view of a portion ‘A’ illustrated in FIG. 1. Referring to FIG. 2, the gate driver part 300 includes a shift register. The shift register includes a plurality of stages including SRC1, SRC2, . . . , SRCk, . . . , SRCn dependently connected to each other. When the shift register is operated, the stages including SRC1, SRC2, . . . , SRCk, . . . , SRCn of the shift register sequentially apply output signals including G1, G2, Gk, . . . , Gnto the first to n-th gate lines based on a scan start signal STVP, a first clock signal CKV, a second clock signal CKVB, a turn-off voltage VSS, first to (k−1)-th carry signals CR1, . . . , CRn−1 and an output signal of the last stage.

In FIGS. 1 and 2, the second side 112 of the first substrate 110 extends in a substantially round shape, the stages including SRC1, SRC2, . . . , SRCk, . . . , SRCn of the shift register may also be arranged in a substantially round shape along the second side 112 of the first substrate 110. Thus, as shown in FIG. 1, when the first substrate 110 has a substantially semi-circular shape, an angle between each stage including SRC1, SRC2, . . . , SRCk, . . . , SRCn and the first side 111 increases from 0 degrees to about 90 degrees, as the stages including SRC1, SRC2, . . . , SRCk, . . . , SRCn are arranged from the first end of the second side 112 to the middle portion of the second side 112. Similar to the above, an angle between each stage including SRC1, SRC2, . . . , SRCk, . . . , SRCn and the first side 111 decreases from about 90 degrees to 0 degrees, as the stages including SRC1, SRC2, . . . , SRCk, . . . , SRCn are arranged from the middle portion of the second side 112 to the second end of the second side 112.

Since the pixel electrodes formed on the first substrate 110 and the corresponding pixels formed on the second substrate 120 are difficult to form in a round shape, one or more pixels, each including the RGB sub-pixels, may be omitted or added at each row so that the whole display area DA has a shape similar to a round shape. For example, when at least a portion of the first substrate 110 is formed to have an arc shape, one of the pixel electrodes and one of the pixels, each including the RGB sub-pixels, are omitted every two rows, and thus a portion of the display area DA may be formed to have an arc shape corresponding to the arc shape of the first substrate 110. Since two stages SRCk and SRCk+1 of the shift register serving as one unit apply output signals Gk and Gk+1 to the gate lines 115, one or more pixels, each including the RGB sub-pixels, may be omitted every two rows.

In addition to the stages including SRC1, SRC2, . . . , SRCk, . . . , SRCn of the shift register, various wirings such as a wiring of the scan start signal STVP, a wiring of the first clock signal CKV, a wiring of the second clock signal CKVB, a wiring of the turn-off voltage VSS, etc. may have a substantially round shape, and may be disposed adjacent to the second side 112 of the second substrate 110.

According to the above, when the gate driver part 300, which includes the shift register arranged in a substantially round shape, is formed directly on the first substrate 110 through a similar process as the process through which the TFTs are formed on the first substrate 110, or formed by using a gate TCP method or a COG method, manufacturing costs and time may be reduced.

When the display area DA has a substantially round shape, lengths of the gate lines 115 formed in the display area DA are different from each other. For example, as shown in FIG. 1, when the display area DA has a semi-circular shape, and the gate lines 115 are substantially parallel with the first side 111, the length of each gate line 115 decreases as the gate lines 115 become distant from the first side 111. When the length of each gate line 115 varies, the capacitance of each gate line 115 also varies. Thus, the gate driver circuit 310 may output a modified driving signal to the gate lines 115 in order to avoid high temperature noise that may occur due to an overload of a transistor formed in the gate driver circuit 310 when the driving signal of the gate driver circuit 310 is maintained in spite of shortened lengths of the gate lines 115.

Accordingly, in FIG. 2, a plurality of load capacitors including C1, C2, . . . , Ck, . . . , Cn are inserted between the stages of the shift register including SRC1, SRC2, . . . , SRCk, . . . , SRCn and the gate lines. The capacitance of the load capacitors including C1, C2, . . . , Ck, . . . , Cn may be inversely proportional to the length of the gate lines 115. For example, when a portion of the display area DA has a semi-circular shape, and the length of the gate lines 115 decreases by the pixels including the RGB sub-pixels, the load capacitor having a predetermined capacitance corresponding to the shortened length of the gate lines 115 may be inserted. In FIG. 2, although a capacitance of a k-th load capacitor Ck of a k-th stage SRCk is the same as a capacitance of a (k+1)-th load capacitor Ck+1 of a (k+1)-th stage SRCk+1, a capacitance of the (k+1)-th load capacitor Ck+1 of the (k+1)-th stage SRCk+1 is greater than a capacitance of a (k+2)-th load capacitor Ck+2 of a (k+2)-th stage SRCk+2 by an amount corresponding to one pixel including RGB sub-pixels. Thus, considering the length of the gate lines 115, the load capacitor Ck is added to the stage SRCk to thereby stably drive the gate lines 115.

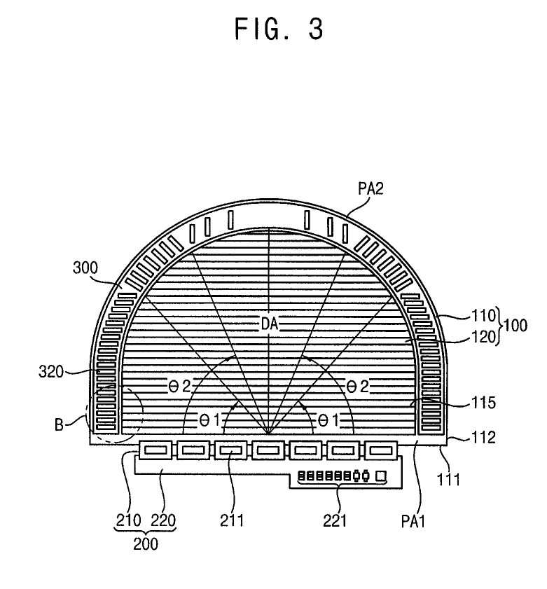

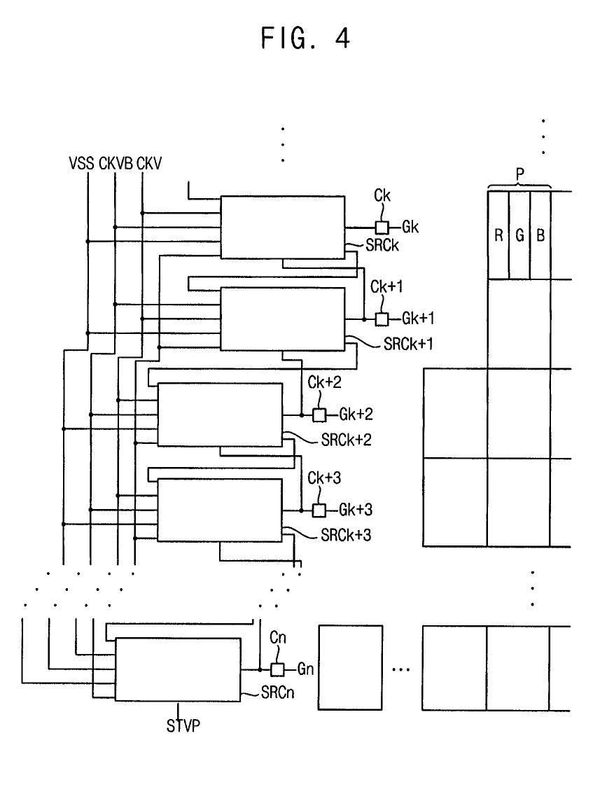

FIG. 3 is a plan view illustrating another example of the gate driver part of the display device illustrated in FIG. 1. FIG. 4 is an enlarged view of a portion ‘B’ illustrated in FIG. 3.

Referring to FIGS. 3 and 4, a display device illustrated in FIGS. 3 and 4 is substantially the same as the display device illustrated in FIGS. 1 and 2 except for the arrangement of the gate driver circuit 320 of the gate driver part 300. Thus, the same reference numerals are used for substantially the same elements, and any further description will be omitted.

The display device includes a display panel 100, a source driver part 200 and a gate driver part 300. The gate driver part 300 is formed in the second non-display area PA2 of the display panel 100. As described above, the gate driver circuit 320 of the gate driver part 300 may be formed directly on the first substrate 110 through a thin film process, and alternatively, the gate driver circuit 320 of the gate driver part 300 may be arranged adjacent to and along the second side 112 of the first substrate 110 by using a TCP method or a COG method.

The gate driver part 300 in FIGS. 3 and 4 includes a shift register. Since the second side 112 of the first substrate 110 extends in a substantially round shape, a plurality of stages including SRC1, SRC2, . . . , SRCk, . . . , SRCn of the shift register may also be arranged in a substantially round shape along the second side 112.

In FIGS. 3 and 4, the stages including SRC1, SRC2, . . . , SRCk, . . . , SRCn are substantially parallel with the first side 111 from the first end of the second side 112 of the first substrate 110 to a first position, arranged to form an angle of about 45 degrees with respect to the first side 111 from the first position to a second position along the second side 112, and arranged to form an angle of about 90 degrees with respect to the first side 111 from the second position to the middle portion of the second side 112 along the second side 112. As shown in FIG. 3, a line between the first position and a center of the first side 111 forms a first angle θ1 with respect to the first side 111, and a line between the second position and the center of the first side 111 forms a second angle θ2 with respect to the first side 111. Similar to the above, when the stages including SRC1, SRC2, . . . , SRCk, . . . , SRCn are also formed from the middle portion of the second side 112 to the second end of the second side 112, the stages including SRC1, SRC2, . . . , SRCk, . . . , SRCn are substantially parallel with the first side 111 from the second end of the second side 112 of the first substrate 110 to a third position, arranged to form an angle of about 45 degrees with respect to the first side 111 from the third position to a fourth position along the second side 112, and arranged to form an angle of about 90 degrees with respect to the first side 111 from the fourth position to the middle portion of the second side 112 along the second side 112. The third and fourth positions correspond to the first and second positions, respectively. As shown in FIG. 3, a line between the third position and a center of the first side 111 forms the first angle θ1 with respect to the first side 111, and a line between the fourth position and the center of the first side 111 forms the second angle θ2 with respect to the first side 111.

Since the pixel electrodes formed on the first substrate 110 and the corresponding pixels formed on the second substrate 120 are difficult to form in a round shape, one or more pixels, each including the RGB sub-pixels, may be omitted or added at each row so that the whole display area DA has a shape similar to a round shape. When one or more pixels are omitted or added, the stages including SRC1, SRC2, . . . , SRCk, . . . , SRCn of the shift register may be formed to maintain a constant distance from the display area DA. For example, as shown in FIG. 4, the stages SRCk and SRCk+1 formed at a k-th row and a (k+1)-th row, in which one pixel is omitted in comparison with an adjacent row, are shifted toward the display area DA by a predetermined distance in comparison with the stages SRCk+2 and SRCk+3 at adjacent (k+2)-th and (k+3)-th rows, so as to maintain a constant distance from the display area DA. Thus, a whole shape of the stages including SRC1, SRC2, . . . , SRCk, . . . , SRCn of the shift register corresponds to the shape of the display area DA.

As shown in FIG. 4, in addition to the stages of the shift register including SRC1, SRC2, . . . , SRCk, . . . , SRCn, various wirings such as a wiring of the scan start signal STVP, a wiring of the first clock signal CKV, a wiring of the second clock signal CKVB, a wiring of the turn-off voltage VSS, etc. may be adjacent to the second side 112 of the second substrate 110, and may correspond to an arrangement shape of the stages including SRC1, SRC2, . . . , SRCk, . . . , SRCn.

In addition, a plurality of load capacitors including C1, C2, . . . , Ck, . . . , Cn may be inserted between the stages including SRC1, SRC2, . . . , SRCk, . . . , SRCn of the shift register and the gate lines 115. The load capacitors including C1, C2, . . . , Ck, . . . , Cn may be formed by using substantially the same method as in FIG. 2. Thus, any further description will be omitted.

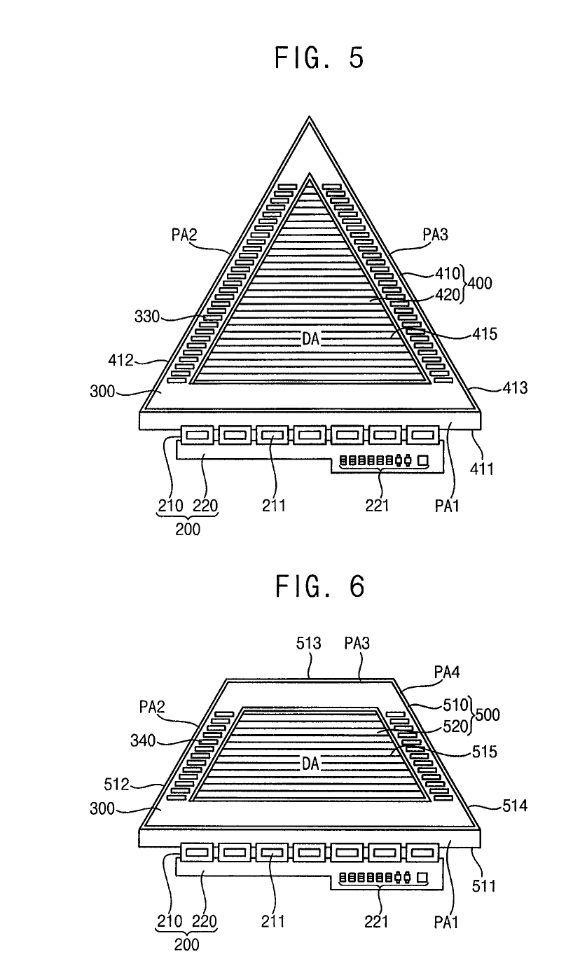

FIG. 5 is a plan view illustrating a display device according to another exemplary embodiment of the present invention.

A display device in FIG. 5 is substantially the same as the display device illustrated in FIGS. 1 to 4 except for the shape of a display panel 400 and the arrangement of a gate driver part 300. Thus, the same reference numerals are used for substantially the same elements, and any further description will be omitted.

Referring to FIG. 5, the display device according to another exemplary embodiment of the present invention includes a display panel 400, a source driver part 200 and a gate driver part 300. The display panel 400 has a display area DA in which an image is displayed and first, second and third non-display areas PA1, PA2 and PA3 located at a periphery of the display area DA. The display panel 400 includes a first substrate 410 and a second substrate 420. The first substrate 410 includes first, second and third sides 411, 412 and 413. The first, second and third sides 411, 412 and 413 define a substantially triangular shape wherein the first side 411 serves as a bottom side. The triangular shape may be an equilateral triangular shape.

The second substrate 420 faces the first substrate 410, and has a shape corresponding to the first substrate 410. The second substrate 420 is disposed to correspond to the display area DA of the first substrate 410. The second substrate 420 is not disposed in the non-display areas PA1, PA2 and PA3 of the first substrate 410. The source driver part 200 and the gate driver part 300 may be formed in the non-display areas PA1, PA2 and PA3 of the first substrate 410.

The source driver part 200 is disposed in the first non-display area PA1, and arranged adjacent to the first side 411 of the first substrate 410. The gate driver part 300 may be disposed in either one or both of the second and third non-display areas PA2 and PA3. That is, the gate driver part 300 may be arranged adjacent to either one or both of the second and third sides 412 and 413 of the first substrate 410. When the gate driver part 300 is formed in both of the second and third non-display areas PA2 and PA3, the gate lines 415 may be stably driven with less power.

As described in FIGS. 1 to 4, a gate driver circuit 330 of the gate driver part 300 may be formed directly on the first substrate 410 through a thin film process, and alternatively, the gate driver circuit 330 of the gate driver part 300 may be arranged adjacent to and along either one or both of the second and third sides 412 and 413 of the first substrate 410 by using a TCP method or a COG method.

The gate driver part 300 includes a shift register, and a plurality of stages including SRC1, SRC2, . . . , SRCk, . . . , SRCn of the shift register may be arranged along either one or both of the second and third sides 412 and 413. Particularly, one or more pixels, each including RGB sub-pixels, formed on the second substrate 420 may be omitted as the pixels become distant from the first side 411 of the first substrate 410, so that the display area DA has a substantially triangular shape. When one or more pixels are omitted, the stages including SRC1, SRC2, . . . , SRCk, . . . , SRCn of the shift register may be formed to maintain a constant distance from the display area DA. Thus, a whole shape of the stages including SRC1, SRC2, . . . , SRCk, . . . , SRCn corresponds to one side or two sides of the triangle.

For example, when the first substrate 410 has a substantially equilateral triangular shape and an angle between the first side 411 and the second side 412 is about 45 degrees, one pixel including the RGB sub-pixels may be omitted every one row to form the display area DA. The stages including SRC1, SRC2, . . . , SRCk, . . . , SRCn of the shift register may be shifted toward the display area DA by a length corresponding to one pixel to maintain a constant distance from the display area DA.

In addition, for example, when the first substrate 410 has a substantially equilateral triangular shape and an angle between the first side 411 and the second side 412 is greater than about 45 degrees, one pixel including the RGB sub-pixels may be omitted every two or more rows to form the display area DA. The stages including SRC1, SRC2, . . . , SRCk, . . . , SRCn of the shift register may be shifted toward the display area DA by a length corresponding to one pixel to maintain a constant distance from the display area DA.

Moreover, for example, when the first substrate 410 has a substantially equilateral triangular shape and an angle between the first side 411 and the second side 412 is smaller than about 45 degrees, two or more pixels, each including the RGB sub-pixels, may be omitted every one row to form the display area DA. The stages including SRC1, SRC2, . . . , SRCk, . . . , SRCn of the shift register may be shifted toward the display area DA by a length corresponding to two or more pixels to maintain a constant distance from the display area DA.

As described in FIGS. 1 to 4, capacitances of load capacitors including C1, C2, . . . , Ck, . . . , Cn, which may be inserted between the stages including SRC1, SRC2, . . . , SRCk, . . . , SRCn of the shift register and the gate lines 415, may be increased as the number of the pixels decreases and the length of the gate lines 415 decreases. Thus, the gate lines 415 may be stably driven.

Although not shown in FIG. 5, in addition to the stages including SRC1, SRC2, . . . , SRCk, . . . , SRCn of the shift register, various wirings such as a wiring of the scan start signal STVP, a wiring of the first clock signal CKV, a wiring of the second clock signal CKVB, a wiring of the turn-off voltage VSS, etc. may be adjacent to either one or both of the second and third sides 412 and 413 of the second substrate 410, and may correspond to an arrangement shape of the stages including SRC1, SRC2, . . . , SRCk, . . . , SRCn.

FIG. 6 is a plan view illustrating a display device according to still another exemplary embodiment of the present invention.

A display device in FIG. 6 is substantially the same as the display device illustrated in FIG. 5 except for the shape of a display panel 500 and the arrangement of a gate driver part 300. Thus, the same reference numerals are used for substantially the same elements, and any further description will be omitted.

Referring to FIG. 6, a display device according to still another exemplary embodiment of the present invention includes a display panel 500, a source driver part 200 and a gate driver part 300. The display panel 500 has a display area DA in which an image is displayed and first, second, third and fourth non-display areas PA1, PA2, PA3 and PA4 located at a periphery of the display area DA. The display panel 500 includes a first substrate 510 and a second substrate 520. The first substrate 510 includes first, second, third and fourth sides 511, 512, 513 and 514. The first, second, third and fourth sides 511, 512, 513 and 514 define a substantially trapezoidal shape wherein the first side 511 serves as a bottom side.

The second substrate 520 faces the first substrate 510, and has a shape corresponding to the first substrate 510. The second substrate 520 is disposed to correspond to the display area DA of the first substrate 510. The second substrate 520 is not disposed in the non-display areas PA1, PA2, PA3 and PA4 of the first substrate 510. The source driver part 200 and the gate driver part 300 may be formed in the non-display areas PA1, PA2, PA3 and PA4 of the first substrate 510.

The source driver part 200 is disposed in the first non-display area PA1, and is arranged adjacent to the first side 511 of the first substrate 510. The gate driver part 300 may be disposed in either one or both of the second and fourth non-display areas PA2 and PA4. That is, the gate driver part 300 may be arranged adjacent to either one or both of the second and fourth sides 512 and 514 of the first substrate 510. When the gate driver part 300 is formed in both of the second and fourth non-display areas PA2 and PA4, the gate lines 415 may be stably driven with less power.

As described in FIG. 5, a gate driver circuit 340 of the gate driver part 300 may be formed directly on the first substrate 510 through a thin film process, and alternatively, the gate driver circuit 340 of the gate driver part 300 may be arranged adjacent to and along either one or both of the second and fourth sides 512 and 514 of the first substrate 510 by using a TCP method or a COG method.

The gate driver part 300 includes a shift register. In FIG. 6, the arrangement and formation of the shift register along the second and fourth sides 512 and 514 is substantially the same as the arrangement and formation of the shift register along the second and third sides 412 and 413. Thus, any further description will be omitted.

According to one or more embodiments of the present invention, a source driver part is connected to a side of a substantially straight line, and a gate driver circuit of a gate driver part is formed adjacent to a side of, for example, a substantially curved line. Thus, a display panel may be manufactured to have various shapes such as a semi-circular shape, a triangular shape, a trapezoidal shape, etc., thereby satisfying various desires of users.

Also, in manufacturing a display panel of a semi-circular shape according to one or more embodiments, the gate driver circuit may be arranged to be substantially parallel with, substantially perpendicular to, or inclined by 45 degrees with respect to the side of a substantially straight line, to easily form the gate driver part. Thus, the manufacturing time and manufacturing costs of the display panel may be reduced.

Furthermore, a capacitance of a capacitor interconnecting an output terminal of each stage and the gate line may be changed to maintain an output signal of the gate line and stably drive the display panel.

Embodiments of the present invention may be employed in various display devices including liquid crystal display (LCD) televisions, LCD monitors, game monitors or any other display device having display panels that may not have rectangular shapes, but may have various other shapes such as a semi-circular shape, a triangular shape, a diamond shape, etc.

Although exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display device comprising:
a display panel displaying an image, the display panel comprising:
a first substrate including a first side extending in a substantially straight line and having a first end and a second end, and a second side extending in a substantially round shape from the first end of the first side to the second end of the first side, a plurality of gate lines formed on the first substrate and substantially parallel with the first side; and
a second substrate facing the first substrate and having a shape corresponding to the first substrate;
a source driver part disposed at the first side to transfer a driving signal to the display panel; and
a gate driver part disposed at the second side and electrically connected to the gate lines to drive the gate lines using a gate driving signal.

2. The display device of claim 1, wherein a gate driver circuit of the gate driver part is directly integrated on the first substrate.

3. The display device of claim 2, wherein the gate driver part comprises a shift register including a plurality of stages dependently connected to each other, and an output terminal of each stage is connected to an associated gate line so that the gate lines are sequentially selected by an output signal of each stage.

4. The display device of claim 3, wherein pixels are connected to the stages, and the number of the pixels, each having red, green and blue sub-pixels, decreases as the stages are arranged from a first end of the second side connected to the first end of the first side to a middle portion of the second side.

5. The display device of claim 4, wherein the stages are arranged substantially parallel with the first side from the first end of the second side to a first position along the second side, arranged to form an angle of about 45 degrees with respect to the first side from the first position to a second position along the second side, and arranged to form an angle of about 90 degrees with respect to the first side from the second position to the middle portion of the second side along the second side.

6. The display device of claim 4, wherein an angle that each stage forms with respect to the first side increases from about 0 degrees to 90 degrees as the stages are arranged from the first end of the second side to the middle portion of the second side.

7. The display device of claim 4, wherein a capacitance of a capacitor interconnecting the output terminal of each stage and the associated gate line increases to stably drive the gate lines as the stages are arranged from the first end of the second side to the middle portion of the second side.

8. The display device of claim 1, wherein the gate driver part is disposed from a first end of the second side connected to the first end of the first side to a middle portion of the second side.

9. The display device of claim 1, wherein the gate driver part is disposed from a first end of the second side connected to the first end of the first side to a second end of the second side connected to the second end of the first side.

10. The display device of claim 1, wherein the gate driver part includes a tape carrier package (TCP) having a flexible printed circuit board (FPCB) and a gate driver chip formed on the FPCB.

11. The display device of claim 1, wherein the gate driver part includes a plurality of gate driver chips, and the gate driver chips are formed on the first substrate by using a chip-on-glass (COG) method.

12. A display device comprising:
a display panel displaying an image, the display panel comprising:
a first substrate including a first side serving as a bottom side, a second side and a third side that define a substantially triangular shape, a plurality of gate lines formed on the first substrate and substantially parallel with the first side; and
a second substrate facing the first substrate and having a shape corresponding to the first substrate;
a source driver part disposed at the first side to transfer a driving signal to the display panel; and
a gate driver part disposed at one or both of the second side and the third side and electrically connected to the gate lines to drive the gate lines using a gate driving signal.

13. The display device of claim 12, wherein the triangular shape defined by the first, second and third sides is an equilateral triangular shape.

14. The display device of claim 13, wherein a gate driver circuit of the gate driver part is directly integrated on the first substrate.

15. The display device of claim 14, wherein the gate driver part comprises a shift register including a plurality of stages dependently connected to each other, and an output terminal of each stage is connected to an associated gate line so that the gate lines are sequentially selected by an output signal of each stage.

16. The display device of claim 15, wherein the stages are arranged substantially parallel with the first side.

17. The display device of claim 16, wherein pixels are connected to the stages, and the number of the pixels, each having red, green and blue sub-pixels, decreases as the stages are arranged from at least one end of the first side along either one or both of the second side and the third side.

18. The display device of claim 17, wherein a capacitance of a capacitor interconnecting the output terminal of each stage and the associated gate line increases, to stably drive the gate lines, as the stages are arranged from at least one end of the first side along either one or both of the second side and the third side.

19. A display device comprising:
a display panel displaying an image, the display panel comprising:
a first substrate including a first side serving as a bottom side, a second side, a third side serving as a top side to be substantially parallel with the first side, and a fourth side that define a substantially trapezoidal shape, a plurality of gate lines formed on the first substrate and substantially parallel with the first side; and
a second substrate facing the first substrate and having a shape corresponding to the first substrate;
a source driver part disposed at the first side to transfer a driving signal to the display panel; and
a gate driver part disposed at one or both of the second side and the fourth side and electrically connected to the gate lines to drive the gate lines using a gate driving signal.

20. The display device of claim 19, wherein a gate driver circuit of the gate driver part is directly integrated on the first substrate.

21. The display device of claim 20, wherein the gate driver part comprises a shift register including a plurality of stages dependently connected to each other, and an output terminal of each stage is connected to an associated gate line so that the gate lines are sequentially selected by an output signal of each stage.

22. The display device of claim 21, wherein the stages are arranged substantially parallel with the first side and the third side.

23. The display device of claim 22, wherein pixels are connected to the stages, and the number of the pixels, each having red, green and blue sub-pixels, decreases as the stages are arranged from at least one end of the first side along either one or both of the second side and the fourth side.

24. The display device of claim 23, wherein a capacitance of a capacitor interconnecting the output terminal of each stage and the associated gate line increases to stably drive the gate lines as the stages are arranged from at least one end of the first side along either one or both of the second side and the fourth side.
